(19) United States
(12) Patent Application Publication
(10) Pub. No.: US 2009/0014403 A1
(43) Pub. Date: Jan. 15, 2009

(54) Liquid and air flow dividing arrangement for baby bottle

(76) Inventor: Chien-Chih Lu, Gueiren Township (TW)

Correspondence Address: BUCKNAM AND ARCHER, 1077 NORTHERN BOULEVARD, ROSLYN, NY, 11576, US

(21) Appl. No.: 11/998,051

(22) Filed: Nov. 28, 2007

(30) Foreign Application Priority Data
Jul. 10, 2007 (TW) 96211187

(51) Int. Cl. A61J 9/04

(52) U.S. Cl. 215/11.5

(57) ABSTRACT

A liquid and air flow dividing arrangement for baby bottle, comprising a bottle body, a nipple and a cover, and a plurality of check valve being provided on the base of the nipple, wherein said liquid and air flow dividing arrangement includes: a disk body fixed between the base of the nipple and the bottle opening by the fastening of the cover, which has a first sleeve provided on the outer side end to insert within the bottle opening of the bottle body and a second sleeve provided on the inner side end to insert on the inner side of the nipple, a recess being formed between the first sleeve and the second sleeve for receiving the check valve; and a pair of branched pipes extended from the side wall of the second sleeve in the center direction, each branched pipe having an air inlet hole communicated with the recess, both branched pipes being combined at the inside to form an air vent pipe extending towards the bottom of the bottle. The milk liquid during the baby feeding moves from the bottle body along one flow passage M, simultaneously the air enters from the other flow passage A into the bottle for quick supplement so as to balance the internal pressure. The interior of the baby bottle thus maintains a positive pressure all the time, so that the baby can suck milk smoothly without much effort.

### BACKGROUND OF THE INVENTION

1. Field of the Invention

The present invention relates to a liquid and air flow dividing arrangement, particularly to a liquid and air flow dividing arrangement, which can divide the milk liquid, flow passage and air flow passage by a disk body.

2. Brief Description of the Prior Art

So far, a lot of pressure balancing arrangement for baby bottle have been proposed, for example a Taiwanese Patent No. 95215330 entitled “Baby Bottle having a Liquid and Air Flow Dividing Arrangement”, as shown in FIGS. 7 and 8, mainly comprises:

a bottle body (10′); a nipple (20′); a cover (30′); and a disk body (40′) having a radial partitioning plate (41′) which is interposed between the base (22) of the nipple (20′) and the bottle opening (12′) by the fastening of the cover (30′) and is used for the segregation of milk liquid, an axial sleeve (42′) being integrally formed at the center of the disk body (40′), the first portion (42a′) of which is extended in the direction of the nipple (20′) and the second portion (4b′) of which is extended in the direction of bottle body (10′), a containing portion (43′) being formed at the center and a plurality of air inlet holes (44′) being formed at the base of first portion (42a′) of the sleeve (42′); a plug portion (50′) received within the containing portion (43′) and having an air flow passage (A′) communicated with the bottle body (10′) and connected to the inner side of the air inlet holes (44′); and a milk liquid flow passage (M′) communicating between the bottle body (10′) and the nipple (20′).

No doubt, the above publication can achieve liquid and air flow division as well as pressure balance within the baby bottle. However, inventor of this invention discovered that the manufacturing of the die for manufacturing above structure needs sophistication in skill and thus the cost is relatively high. It is this consideration that makes the inventor to devote to the simplification on the structure of the baby bottle, and thus the novel baby bottle of this invention is realized.

### SUMMARY OF THE INVENTION

The main object of this invention is to provide a liquid and air flow dividing arrangement for baby bottle in which air is supplemented instantly to reach internal pressure equilibrium at the same time with the discharge of the milk liquid, so that the baby can suck milk smoothly without much effort.

The other object of this invention is to provide a liquid and air flow dividing arrangement for baby bottle in which the milk liquid and the air is concretely segregated so as to avoid the mixing or dissolving of air into the milk liquid. In this manner, the sucking of milk liquid containing air by baby can be avoided.

In order to achieve the above objects, the liquid and air flow dividing arrangement for baby bottle of the present invention comprising a bottle body, a nipple and a cover, and a plurality of check valve being provided on the base of the nipple, wherein said liquid and air flow dividing arrangement includes:

a disk body fixed between the base of the nipple and the bottle opening by the fastening of the cover, which has a first sleeve provided on the outer side end to insert within the bottle opening of the bottle body and a second sleeve provided on the inner side to insert on the inner side of the nipple, a recess being formed between the first sleeve and the second sleeve for receiving the check valve; and

a pair of branched pipes extended from the side wall of the second sleeve in the center direction, each branched pipe having an air inlet hole communicating with the recess, both branched pipes being combined at the inside to form a air vent pipe extending towards the bottom of the bottle.

According to the liquid and air flow dividing arrangement for baby bottle of the present invention, the milk liquid during the baby feeding moves from the bottle body along the milk liquid flow passage M at the center of the second sleeve and discharges to the nipple, at the same time, the air enters from the check valve of the nipple to the recess of the disk body and then enters into the air vent pipe after passing through the pair of branched pipes from the air inlet hole. Thus an air flow passage A is formed in this manner to supplement air into the bottle body. In this way, the milk liquid is discharged through one flow passage, simultaneously the air is supplemented through the other flow passage to balance the internal pressure of the bottle. The interior of the baby bottle thus maintains a positive pressure all the time, so that the baby can suck milk smoothly without much effort.

In addition, the milk liquid and the air are ensured to be segregated so as to avoid the mixing or dissolving of air into the milk liquid. In this manner, the sucking of milk liquid containing air by baby can be prevented, otherwise the milk liquid containing air often causes flatulence.

According to this invention, the integral structure of the disk body results in the remarkable reduction of the part quantity which induces simplification on the whole configuration and total cost reduction.

### BRIEF DESCRIPTION OF THE DRAWINGS

FIG. 1 is a perspective view showing the exploded state of the liquid and air flow dividing arrangement for baby bottle of the present invention, in which the baby bottle is omitted.

FIG. 2 is a schematic sectional view showing the assembled state of the liquid and air flow dividing arrangement for baby bottle of the present invention.

FIG. 3 is a schematic partially sectional view showing the using state of the liquid and air flow dividing arrangement for baby bottle of the present invention, in which the arrow A is the air flow passage and the arrow M shows the milk liquid flow passage.

FIG. 4 is a perspective view showing the exploded state of the air vent pipe and membrane valve of the present invention.

FIG. 5 is a schematic sectional view showing the assembled state of the air vent pipe and the membrane valve in FIG. 4.

FIG. 6 is a schematic sectional view showing the using state of the air vent pipe and the membrane valve of the present invention, in which the arrow A is an air flow passage.

FIG. 7 is a perspective view showing the exploded state of a conventional baby bottle having a liquid and air flow dividing arrangement of Taiwanese Patent No. 95215330.

FIG. 8 is a schematic sectional view showing the conventional baby bottle having a liquid and air flow dividing arrangement in FIG. 7, in which the arrow A′ is an air flow passage.

FIG. 9 is another schematic sectional view showing the conventional baby bottle having a liquid and air flow dividing arrangement in FIG. 7, in which the arrow M′ is milk liquid flow passage.

### DETAILED DESCRIPTION OF THE PREFERRED EMBODIMENTS

The technical features of the present invention will become more apparent by the detailed description of following embodiments, which are merely for illustrative purpose rather than restrictive on the scope of the present invention, in conjunction with the attached drawings.

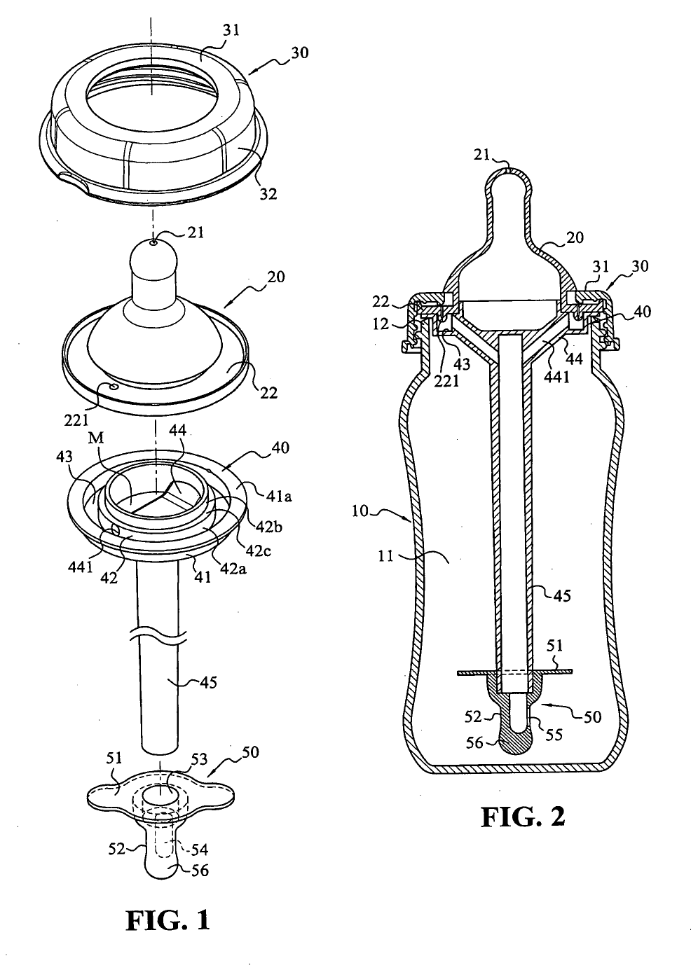

Firstly referring to FIGS. 1, 2 and 3, an embodiment of the liquid and air flow dividing arrangement for baby bottle will be described. The baby bottle mainly comprises a bottle body 10 one end of which is a containing portion 11 for accommodating milk liquid and the other end of which is a bottle opening 12; a nipple 20 one end of which is a discharge port 21 for discharging milk liquid and the other end of which is a base portion 22 enlarged in the radial direction, a pair of check valve 221 are provided oppositely to each other on the base portion 22; A cover 30 one end of which has a holding portion 32 for pressing onto the base portion 22 of the nipple 20 during the fastening of the cover and the other end of which is formed with a engagement portion 32 for engaging with the outside of the bottle opening 12. The liquid and air flow dividing arrangement comprises:

a disk body 40 fixed between the base 22 of the nipple 20 and the bottle opening 12 by the fastening of the cover 30, which has a first sleeve 41 provided on the outer side to insert within the bottle opening 12 of the bottle body 10 and a second sleeve 42 provided on the inner side to insert on the inner side of the nipple 20, the first sleeve 41 and the second sleeve 42 is connected by a recess 43 for receiving the check valve 221; and

a pair of branched pipes 44 extended from the side wall of the second sleeve 42 in the center direction, each branched pipe 44 has an air inlet hole 441 communicating with the recess 43, both branched pipes 44 are combined at the inside to form a air vent pipe 45 extending towards the bottom of the bottle body 10, an one-way valve 50 is connected to the lower end of the air vent pipe 45.

According to this embodiment, a flange portion 41a formed on the upper end of the first sleeve 41 and protruding radially outwards is interposed between the base portion 22 of the nipple 20 and the bottle opening 12. The second sleeve 42 includes an upper portion 42b and a lower portion 42a, an abutment surface 42c having the same level with the flange portion 41a is formed between the upper portion 42b and the lower portion 42a to abut with the base portion 22 of the nipple 20. The outside periphery of the upper portion 42b of the second sleeve 42 is in close contact with the inner side of the base of the nipple 20. A milk liquid flow passage M is formed through the central portion of the second sleeve 42 along the outside of the pair of branched pipes 44. The person skill in the art can understand that the pair of branched pipes can be integral or separately connected with the air vent pipe 45.

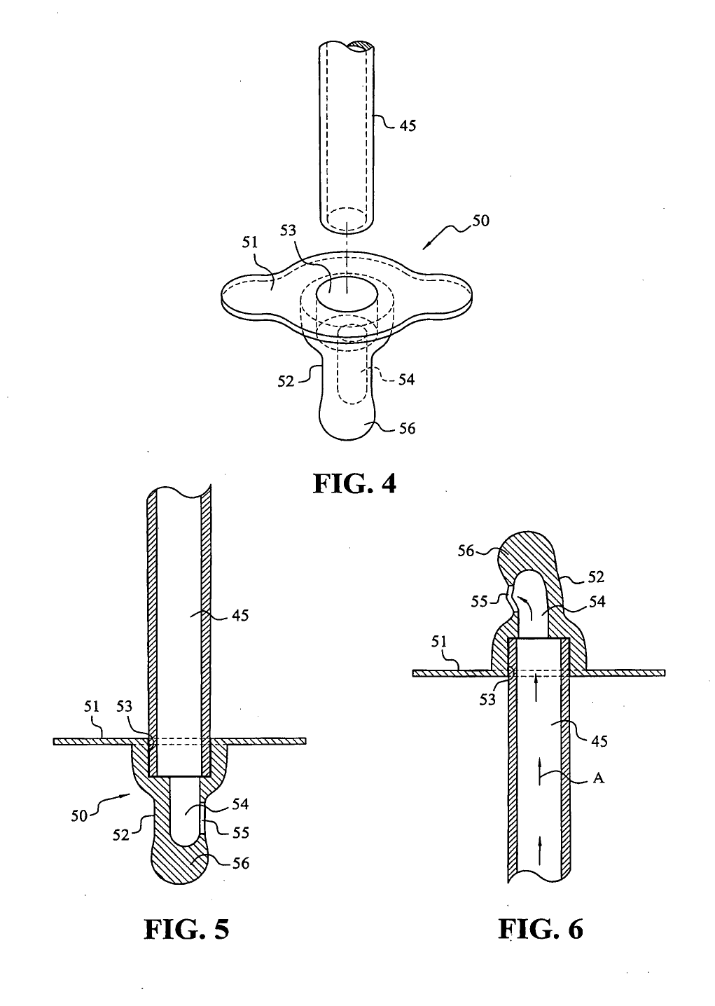

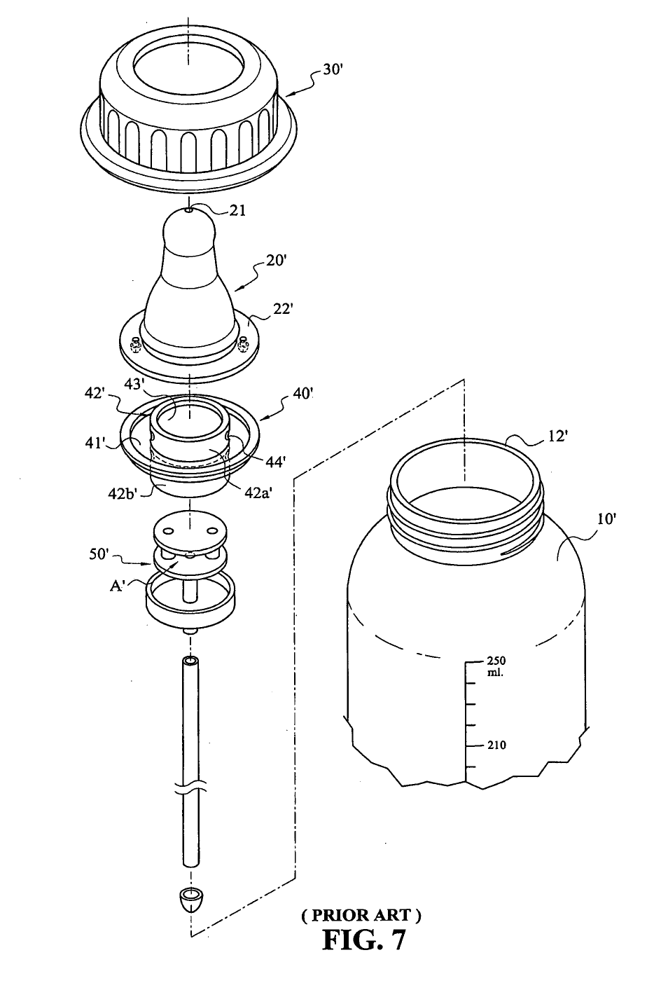

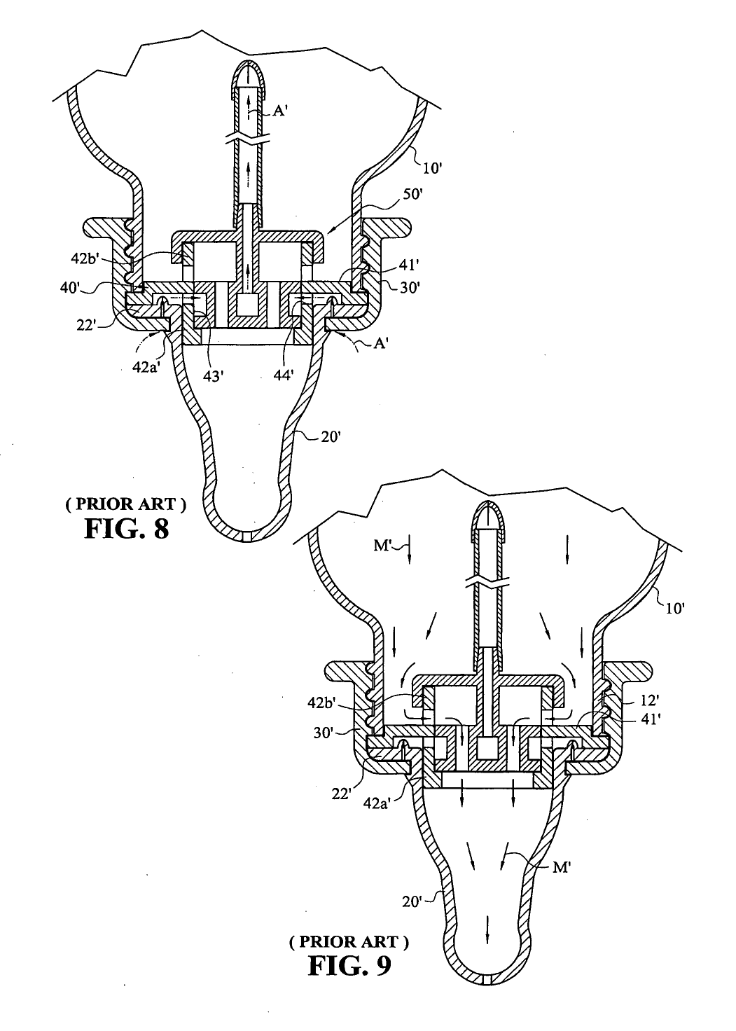

Referring to FIGS. 4, 5 and 6, a horizontal portion 51 extending in horizontal direction is formed on the topside of the valve 50, and a vertical portion 52 extending in the vertical direction is formed at the lower side of the horizontal portion 51. An engagement portion 53 to engage with the end of the air vent pipe 45 is provided at the center of the horizontal portion 51. A cavity 54 is formed within the vertical portion as shown in FIG. 5, which is arranged to be eccentric in the longitudinal section of the vertical portion 52. Thus, one side of the cavity 54 has larger wall thickness, and the other side of the cavity 54 has thinner wall thickness. A slit 55 is provided on the thinner sidewall of the vertical portion 52, which communicates with the cavity 54. A weight 56 is formed at the bottom of the vertical portion 52 by the same material so that the weight 56 is biased towards the thinner sidewall to cause the slit 55 open wider. In this manner, the deformation of the slit 55 can make the air flow passage A unclogged, as shown in FIG. 6.

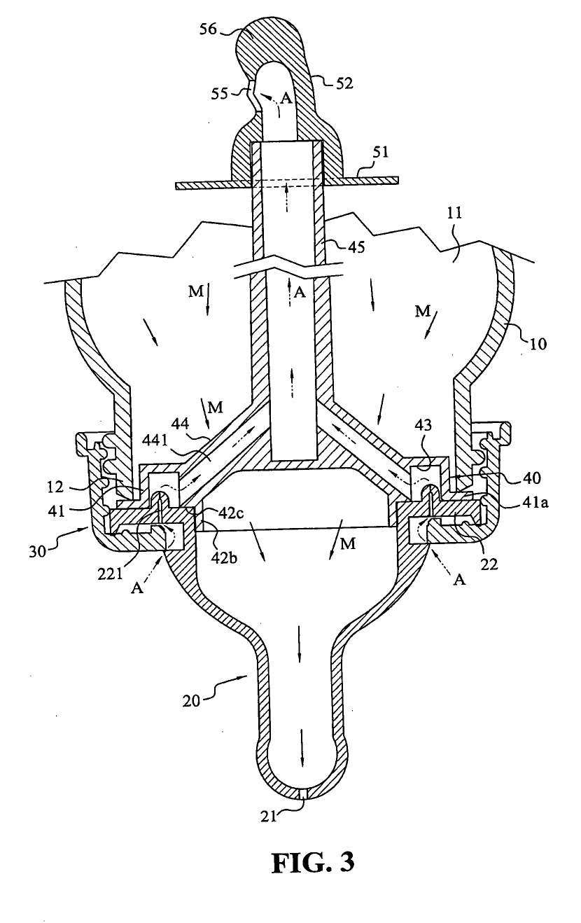

As shown in FIG. 3, according to this embodiment, the milk liquid during the baby feeding moves from the bottle body 10 along the milk liquid flow passage M at the center of the second sleeve 42 to the discharge port 21 of the nipple 20, simultaneously the air enters from the check valve 221 of the nipple 20 under the action of the negative pressure in the bottle body 10 to the recess 43 of the disk body 40 and then enters into the air vent pipe 45 after passing through the pair of branched pipes 44 from the air inlet hole 441. Thus an air flow passage A through the valve 50 is formed to supplement air into the bottle body.

According to the above liquid and air flow dividing arrangement for baby bottle, the milk liquid during the baby feeding moves from the bottle body along one flow passage M, simultaneously the air enters from the other flow passage A into the bottle for quick supplement so as to balance the internal pressure. The interior of the baby bottle thus maintains a positive pressure all the time, so that the baby can suck milk smoothly without much effort. In addition, the milk liquid and the air are ensured to be segregated so as to avoid the mixing or dissolving of air into the milk liquid. In this manner, the sucking of milk liquid containing air by baby can be prevented, otherwise the milk liquid containing air often causes flatulence.

Summing up above, the liquid and air flow dividing arrangement of the present invention has all the abovementioned advantages and the parts quantities is significantly reduced due to simplification on structure so as to get the merit of cost-down.

The above embodiments are for illustrative purpose only, not for the restriction of the scope of the present invention. It is noted that various modifications and variations made without departing from the spirit and principle of the present invention are considered still to be within the scope of the present invention.

What is claimed is:

1. A liquid and air flow dividing arrangement for baby bottle, comprising a bottle body (10), a nipple (20) and a cover (30), a plurality of check valve (221) being provided on the base (22) of the nipple (20), wherein said liquid and air flow dividing arrangement includes:
a disk body (40) fixed between the base (22) of said nipple (20) and the bottle opening (12) by the fastening of said cover (30), which has a first sleeve (41) provided on the outer side to insert within said bottle opening (12) of said bottle body (10) and a second sleeve (42) provided on the inner side to insert on the inner side of said nipple (20), a recess (43) being formed between said first sleeve (41) and said second sleeve (42) for receiving said check valve (221); and
a pair of branched pipes (44) extended from the side wall of said second sleeve (42) in the center direction, each branched pipe (44) having an air inlet hole (441) communicating with said recess (43), both branched pipes (44) being combined at the inside to form an air vent pipe (45) extending towards the bottom of said bottle body (10).

2. A liquid and air flow dividing arrangement for baby bottle as claimed in claim 1, wherein air enters from said check valve (221) of the nipple (20) under the action of the negative pressure in said bottle body (10) to the recess (43) of said disk body (40) and then enters into said air vent pipe (45) to form an air flow passage (A).

3. A liquid and air flow dividing arrangement for baby bottle as claimed in claim 2, wherein a one-way valve (50) is connected at the lower end of said air vent pipe (45).

4. A liquid and air flow dividing arrangement for baby bottle as claimed in claim 3, wherein a flange portion (41a) formed on the upper end of said first sleeve (41) and protruding radially outwards is interposed between said base portion (22) of said nipple (20) and said bottle opening (12).

5. A liquid and air flow dividing arrangement for baby bottle as claimed in claim 4, wherein said second sleeve (42) includes an upper portion (42b) and a lower portion (42a), an abutment surface (42c) having the same level with said flange portion (41a) is formed between said upper portion (42b) and said lower portion (42a) to abut with the base portion (22) of said nipple (20).

6. A liquid and air flow dividing arrangement for baby bottle as claimed in claim 5, wherein the outside periphery of said upper portion (42b) of the second sleeve (42) is in close contact with the inner side of the base of said nipple (20).

7. A liquid and air flow dividing arrangement for baby bottle as claimed in claim 6, wherein a milk liquid flow passage (M) is formed through the central portion of said second sleeve (42) along the outside of said pair of branched pipes (44).

8. A liquid and air flow dividing arrangement for baby bottle as claimed in claim 7, wherein said milk liquid flow passage (M) is completely segregated from said air flow passage (A).

9. A liquid and air flow dividing arrangement for baby bottle as claimed in claim 1, wherein a pair of check valve (221) protruding into the recess (43) are provided oppositely to each other in radial direction on said base portion (22) of the nipple (20).

10. A liquid and air flow dividing arrangement for baby bottle as claimed in claim 1, wherein said branched pipes (44) are formed integrally with said air vent pipe (45).

11. A liquid and air flow dividing arrangement for baby bottle as claimed in claim 1, wherein said branched pipes (44) are separately connected with said air vent pipe (45).

12. A liquid and air flow dividing arrangement for baby bottle as claimed in claim 3, wherein a horizontal portion (51) extending in horizontal direction is formed on the top side of said valve (50), and a vertical portion (52) extending in the vertical direction is formed at the lower side of said horizontal portion (51), an engagement portion (53) to engage with the end of said air vent pipe (45) is provided at the center of said horizontal portion (51), a cavity (54) is formed within the vertical portion (52) to communicate with a slit (55) provided on the side wall of said vertical portion (52).

13. A liquid and air flow dividing arrangement for baby bottle as claimed in claim 12, wherein said cavity (54) is arranged to be eccentric in the longitudinal section of said vertical portion (52) such that one side of the cavity (54) has larger wall thickness and the other side has thinner wall thickness.

14. A liquid and air flow dividing arrangement for baby bottle as claimed in claim 13, wherein said slit (55) is provided on the thinner sidewall of the vertical portion (52).

15. A liquid and air flow dividing arrangement for baby bottle as claimed in claim 14, wherein a weight (56) is formed at the bottom of said vertical portion (52).
